(19) United States
(12) Patent Application Publication
(10) Pub. No.: US 2012/0273255 A1
(43) Pub. Date: Nov. 1, 2012

(54) Electrical Conductors Having Organic Compound Coatings

(75) Inventors: Jessica Henderson Brown Hemond, Mifflintown, PA (US); Andrew Nicholas Loyd, Dillsburg, PA (US); Rodney Ivan Martens, Mechanicsburg, PA (US); Jian Wang, Fremont, CA (US)

(73) Assignee: Tyco Electronics Corporation, Berwyn, PA (US)

(21) Appl. No.: 13/404,711

(22) Filed: Feb. 24, 2012

Related U.S. Application Data
(60) Provisional application No. 61/517,781, filed on Apr. 26, 2011.

(51) Int. Cl. B32B 15/04; B82Y 30/00

(52) U.S. Cl. 174/126.2; 977/932

(57) ABSTRACT

An electrical conductor includes a metallic substrate having a surface and an organic compound coating deposited on the surface. The organic compound coating may comprise a graphene coating, a carbon nanotube (CNT) coating or a blended graphene/CNT coating. The organic compound coating defines a separable interface of the electrical conductor configured to be mated to and unmated from a mating conductor. The organic compound coating is electrically conductive. The organic compound coating has a lower friction coefficient than the surface of the metallic substrate.

### CROSS REFERENCE TO RELATED APPLICATIONS

This application claims the benefit of U.S. Provisional Application No. 61/517,781 filed Apr. 26, 2011, the subject matter of which is herein incorporated by reference in its entirety.

### BACKGROUND OF THE INVENTION

The subject matter herein relates generally to electrical conductors having organic compound coatings.

Electrical conductors have many forms, such as a contact, a terminal, a pin, a socket, an eye-of-needle pin, a micro-action pin, a compliant pin, a wire, a cable braid, a trace, a pad and the like. Such electrical conductors are used in many different types of products or devices, including electrical connectors, cables, printed circuit boards, and the like. Lubricants are used on some electrical conductors to reduce wear and friction. Known lubricants include graphite applied to the metallic substrate of the electrical conductor. While graphite functions well to reduce wear and friction, graphite has high contact resistance. When graphite is applied to the metallic substrate, the electrical properties are diminished, sometimes to the point of excessive signal degradation. Use of graphite on electrical conductors has not typically been successfully implemented for low voltage/current electrical contacts.

A need remains for an electrical conductor having reduced friction, wear and contact resistance.

### BRIEF DESCRIPTION OF THE INVENTION

In one embodiment, an electrical conductor is provided including a metallic substrate having a surface and an organic compound coating deposited on the surface. The organic compound coating may comprise a graphene coating, a carbon nanotube (CNT) coating or a blended graphene/CNT coating. The organic compound coating defines a separable interface of the electrical conductor configured to be mated to and unmated from a mating conductor. The organic compound coating is electrically conductive. The organic compound coating has a lower friction coefficient than the surface of the metallic substrate.

Optionally, the organic compound coating may be deposited directly on the metallic substrate. The organic compound layer may be doped with metallic particles.

Optionally, multiple organic compound coating layers may be provided with flash metallic layers interspersed therebetween. The organic compound layers may be exposed through pores in the flash metallic layers.

Optionally, the metallic substrate may include a base substrate layer and a surface layer deposited on the base substrate layer. The base substrate layer may be a copper or a copper alloy. The surface layer may be silver, tin, palladium, gold or alloy thereof. The organic compound coating may be deposited directly on the base substrate layer. The organic compound coating may be deposited directly on the surface layer.

Optionally, the organic compound coating may be spray coated on the metallic substrate, may be brushed on the metallic substrate or may be plated on the metallic substrate.

### BRIEF DESCRIPTION OF THE DRAWINGS

FIG. 1 is a cross sectional view of a portion of an electrical conductor formed in accordance with an exemplary embodiment.

FIG. 2 is a cross sectional view of a portion of an electrical conductor formed in accordance with an exemplary embodiment.

FIG. 3 is a cross sectional view of a portion of an electrical conductor formed in accordance with an exemplary embodiment.

FIG. 4 is a cross sectional view of a portion of an electrical conductor formed in accordance with an exemplary embodiment.

### DETAILED DESCRIPTION OF THE INVENTION

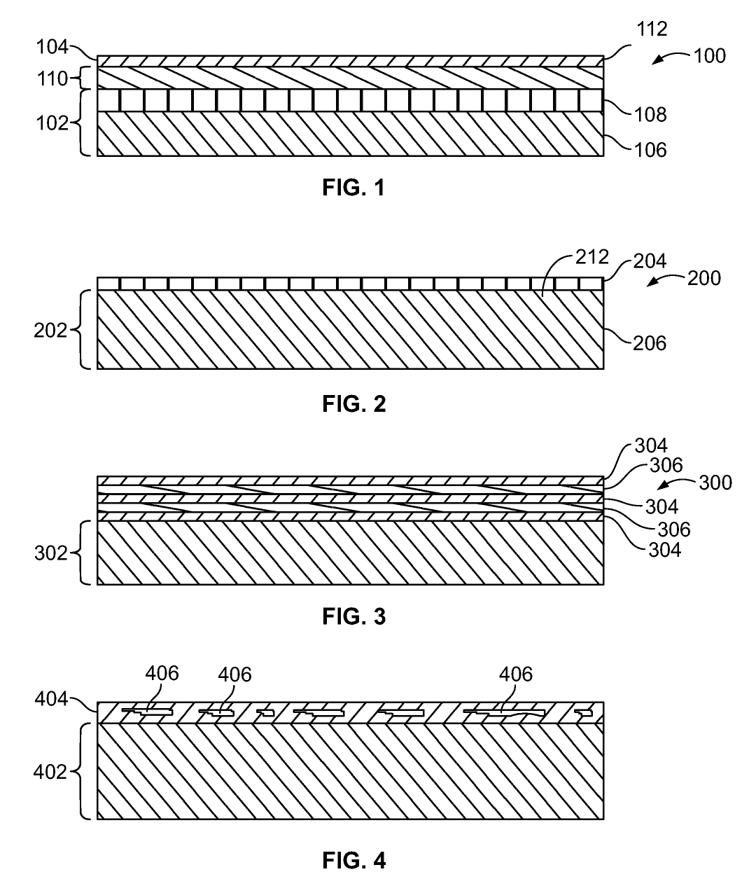

FIG. 1 is a cross sectional view of a portion of an electrical conductor 100 formed in accordance with an exemplary embodiment. The electrical conductor 100 may be any type of electrical conductor, such as a contact, a terminal, a pin, a socket, an eye-of-needle pin, a micro-action pin, a compliant pin, a wire, a cable braid, a trace, a pad and the like. The electrical conductor 100 may form part of an electrical connector, a cable, a printed circuit board a solar panel and the like.

In an exemplary embodiment, the electrical conductor 100 is a multi-layered structure having a metallic substrate 102 and an organic compound coating 104 deposited on the metallic substrate 102. The organic compound coating 104 may be added to reduce wear on the metallic substrate 102. The organic compound coating 104 may be added to reduce friction on the metallic substrate 102. The organic compound coating 104 may be added in place of other types of lubricants or coatings that have relatively high contact resistance, such as graphite. The organic compound coating 104 has a lower contact resistance, and is thus more electrically conductive, than graphite. In an exemplary embodiment, the organic compound coating 104 is or contains graphene. In another exemplary embodiment, the organic compound coating 104 is or contains carbon nanotubes (CNTs). In another exemplary embodiment, the organic compound coating 104 is a blended organic compound coating 104 including both graphene and CNTs. Other organic compounds may be used having characteristics of being electrically conductive and having a relatively low friction coefficient, such as compared to the metallic substrate 102.

In an exemplary embodiment, the metallic substrate 102 is a multi-layered structure. In the illustrated embodiment, the metallic substrate 102 includes a base substrate layer 106, a barrier substrate layer 108 deposited on the base substrate layer 106, and a surface layer 110 deposited on the barrier substrate layer 108. Optionally, the base substrate layer 106, the barrier substrate layer 108 and/or the surface layer 110 may be a multi-layered structure.

In an exemplary embodiment, the base substrate layer 106 is electrically conductive and includes a metal compound, such as a copper or a copper alloy. Other metal compounds may be used in alternative embodiments for the base substrate layer 106 other than a copper or copper alloy, such as nickel, nickel alloy, steel, steel alloy, aluminum, aluminum alloy, palladium-nickel, tin, tin alloy, cobalt, carbon, graphite, graphene, carbon-based fabric, or any other conductive material. The barrier substrate layer 108 is electrically conductive and includes a metal compound, such as nickel or a nickel alloy. Other metal compounds for the barrier substrate layer 108 include other metal or conductive material such as copper, gold, silver, cobalt, tungsten, platinum, palladium, or alloys of such. The barrier substrate layer 108 provides a diffusion barrier between the base substrate layer 106 and the surface layer 110, such as when such layers are copper and gold or other metal compounds that have diffusion problems. The barrier substrate layer 108 provides mechanical backing for the surface layer 110, which may be relatively thin, improving its wear resistance. The barrier substrate layer 108 reduces the impact of pores present in the surface layer 110. The barrier substrate layer 108 may be deposited on the base substrate layer 106 by any known process, such as plating. Optionally, the barrier substrate layer 108 may be deposited directly on the underlying base substrate layer 106. Alternatively, one or more other layers may be provided between the barrier substrate layer 108 and the base substrate layer 106.

The surface layer 110 provides a corrosion-resistant electrically conductive layer on the base substrate layer 106. For example, the surface layer 110 may include a metal compound such as gold, silver, tin, nickel, palladium, palladium-nickel, platinum and the like, or alloys thereof. The surface layer 110 is generally a thin layer. The surface layer 110 may be deposited on the barrier substrate layer 108 by any known process, such as plating. Optionally, the surface layer 110 may be deposited directly on the underlying barrier substrate layer 108. Alternatively, one or more other layers may be provided between the surface layer 110 and the barrier substrate layer 108. In other alternative embodiments, the surface layer 110 may be deposited directly on the base substrate layer 106 without the use of a barrier substrate layer therebetween. In other alternative embodiments, the metallic substrate 102 may only include the base substrate layer 106 without the use of a barrier substrate layer or surface layer.

The organic compound coating 104 is deposited on the surface layer 110. The surface layer 110 includes an outer surface 112 that defines the outermost surface of the metallic substrate 102 (the outer surface may be defined by the base substrate layer 106 or other layers in alternative embodiments). The organic compound coating 104 is deposited directly on the outer surface 112. The organic compound coating 104 is located exterior of the metallic substrate 102. The organic compound coating 104 defines a separable interface of the electrical conductor 100 that is configured to be mated to and unmated from a mating conductor. The organic compound coating 104 is used to define the separable interface because the organic compound coating 104 has good wear resistance, friction resistance and electrical conductivity. The organic compound coating 104 has a lower friction coefficient than the outer surface 112 of the metallic substrate 102.

The organic compound coating 104 is deposited by an application process. For example, the organic compound coating 104 may be deposited using a spray coating process. A solution of solvent, base CNT and/or graphene materials and/or surfactants is spray coated on the metallic substrate 102. Heat may then be applied to remove the solvent. In other embodiments, the organic compound coating 104 may be deposited by other application processes, such as brushing, plating, dip coating and the like.

FIG. 2 is a cross sectional view of a portion of an electrical conductor 200 formed in accordance with an exemplary embodiment. The electrical conductor 200 is similar to the electrical conductor 100 (shown in FIG. 1), however the electrical conductor 200 does not include a barrier substrate layer or a surface layer.

The electrical conductor 200 includes a metallic substrate 202 and an organic compound coating 204 deposited on the metallic substrate 202. The organic compound coating 204 may be added to reduce wear on the metallic substrate 202. The organic compound coating 204 may be added to reduce friction on the metallic substrate 202. The organic compound coating 204 may be similar to the organic compound coating 104 (shown in FIG. 1). The organic compound coating 204 may be graphene, CNTs or a blend of graphene and CNTs.

The metallic substrate 202 includes a base substrate layer 206. The base substrate layer 206 is electrically conductive and includes a metal compound, such as a copper or a copper alloy. Other metal compounds may be used in alternative embodiments for the base substrate layer 206 other than a copper or copper alloy.

The organic compound coating 204 is deposited on the base substrate layer 206. The base substrate layer 206 includes an outer surface 212 that defines the outermost surface of the metallic substrate 202. The organic compound coating 204 is deposited directly on the outer surface 212. The organic compound coating 204 is located exterior of the metallic substrate 202. The organic compound coating 204 defines a separable interface of the electrical conductor 200 that is configured to be mated to and unmated from a mating conductor. The organic compound coating 204 is used to define the separable interface because the organic compound coating 204 has good wear resistance, friction resistance and electrical conductivity. The organic compound coating 204 has a lower friction coefficient than the outer surface 212 of the metallic substrate 202. Optionally, the organic compound coating 204 may provide corrosion resistance for the base substrate layer 206.

FIG. 3 is a cross sectional view of a portion of an electrical conductor 300 formed in accordance with an exemplary embodiment. The electrical conductor 300 is similar to the electrical conductor 200 (shown in FIG. 2), however the electrical conductor 300 includes metallic layers interspersed with organic compound coating layers as opposed to a single organic compound coating layer. The electrical conductor 300 may include other layers, such as a barrier substrate layer, a surface layer or other layers in alternative embodiments.

The electrical conductor 300 includes a metallic substrate 302 and a series of organic compound coatings 304 and flash metallic layers 306 deposited on the metallic substrate 302. The flash metallic layers 306 are interspersed between the organic compound coatings 304. A multi-layered organic compound coating layer is thus provided. The organic compound coatings 304 reduce wear on the metallic substrate 302 and flash metallic layers 306. The organic compound coatings 304 reduce friction for mating with a mating conductor, such as sliding mating. The organic compound coatings 304 may be graphene, CNTs or a blend of graphene and CNTs.

In an exemplary embodiment, the organic compound coatings 304 have a higher wear resistance and a lower friction coefficient than the flash metallic layers 306, while the flash metallic layers 306 have a higher electrical conductivity than the organic compound coatings 304. The flash metallic layers 306 may be porous. The organic compound coatings 304 may be exposed through the pores in the flash metallic layers 306. Such exposure reduces wear and friction on the flash metallic layers 306. Having the flash metallic layers 306 close to the separable interface defined at the outermost surface of the electrical conductor 300 increases the electrical conductivity to the metallic substrate 302.

FIG. 4 is a cross sectional view of a portion of an electrical conductor 400 formed in accordance with an exemplary embodiment. The electrical conductor 400 is similar to the electrical conductor 200 (shown in FIG. 2), however the electrical conductor 400 the organic compound coating is doped with metallic particles, such as metallic flakes. The electrical conductor 400 may include other layers, such as a barrier substrate layer, a surface layer or other layers in alternative embodiments.

The electrical conductor 400 includes a metallic substrate 402 and an organic compound coating 404 being doped with metallic particles 406. The metallic particles 406 may be metallic flakes. The metallic particles 406 may be atomic in size. The metallic particles 406 are embedded in the organic compound coating 404. The organic compound coating 404 reduces wear on the metallic substrate 402. The organic compound coating 404 reduces friction for mating with a mating conductor, such as sliding mating. The organic compound coating 404 may be graphene, CNTs or a blend of graphene and CNTs. The metallic particles 406 increase the electrical conductivity of the organic compound coating 404.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An electrical conductor comprising:
a metallic substrate having a surface; and
a graphene coating deposited on the surface, the graphene coating defining a separable interface of the electrical conductor configured to be mated to and unmated from a mating conductor, the graphene coating being electrically conductive, the graphene coating having a lower friction coefficient than the surface of the metallic substrate.

2. The electrical conductor of claim 1, wherein the graphene coating is deposited directly on the metallic substrate.

3. The electrical conductor of claim 1, wherein the graphene coating is doped with metallic particles.

4. The electrical conductor of claim 1, wherein multiple graphene coating layers are provided with flash metallic layers interspersed therebetween.

5. The electrical conductor of claim 4, wherein the graphene coating layers are exposed through pores in the flash metallic layers.

6. The electrical conductor of claim 1, wherein the metallic substrate comprises a base substrate layer, the base substrate layer comprising copper or a copper alloy, the graphene coating being deposited directly on the base substrate layer.

7. The electrical conductor of claim 1, wherein the metallic substrate comprises a base substrate layer and a surface layer deposited on the base substrate layer, the surface layer comprising silver, tin, palladium, gold or alloy thereof, the graphene coating being deposited directly on the surface layer.

8. The electrical conductor of claim 1, wherein the graphene coating is a spray coated layer on the metallic substrate.

9. The electrical conductor of claim 1, wherein the graphene coating is one of spray coated, brushed or plated on the metallic substrate.

10. An electrical conductor comprising:
a metallic substrate having a surface; and
a carbon nanotube (CNT) coating deposited on the surface, the CNT coating defining a separable interface of the electrical conductor configured to be mated to and unmated from a mating conductor, the CNT coating being electrically conductive, the CNT coating having a lower friction coefficient than the surface of the metallic substrate.

11. The electrical conductor of claim 10, wherein the CNT coating is doped with metallic particles.

12. The electrical conductor of claim 10, wherein multiple CNT coating layers are provided with flash metallic layers interspersed therebetween, the CNT coating layers being exposed through pores in the flash metallic layers.

13. The electrical conductor of claim 10, wherein the metallic substrate comprises a base substrate layer, the base substrate layer comprising copper or a copper alloy, the CNT coating being deposited directly on the base substrate layer.

14. The electrical conductor of claim 10, wherein the metallic substrate comprises a base substrate layer and a surface layer deposited on the base substrate layer, the surface layer comprising silver, tin, palladium, gold or alloy thereof, the CNT coating being deposited directly on the surface layer.

15. The electrical conductor of claim 10, wherein the CNT coating is one of spray coated, brushed or plated on the metallic substrate.

16. An electrical conductor comprising:
a metallic substrate having a surface; and
a blended organic compound coating deposited on the surface, the blended organic compound coating comprising a blend of graphene and carbon nanotubes (CNTs), the blended organic compound coating defining a separable interface of the electrical conductor configured to be mated to and unmated from a mating conductor, the blended organic compound coating being electrically conductive, the blended organic compound coating having a lower friction coefficient than the surface of the metallic substrate.

17. The electrical conductor of claim 16, wherein the blended organic compound coating is doped with metallic particles.

18. The electrical conductor of claim 16, wherein multiple blended organic compound coating layers are provided with flash metallic layers interspersed therebetween, the blended organic compound coating layers being exposed through pores in the flash metallic layers.

19. The electrical conductor of claim 16, wherein the metallic substrate comprises a base substrate layer, the base substrate layer comprising copper or a copper alloy, the blended organic compound coating being deposited directly on the base substrate layer.

20. The electrical conductor of claim 16, wherein the metallic substrate comprises a base substrate layer and a surface layer deposited on the base substrate layer, the surface layer comprising silver, tin, palladium, gold or alloy thereof, the blended organic compound coating being deposited directly on the surface layer.
